(19) United States
(12) Patent Application Publication
(10) Pub. No.: US 2010/0128047 A1
(43) Pub. Date: May 27, 2010

(54) COMMODITY SALES DATA PROCESSING APPARATUS AND CONTROL METHOD THEREFOR

(75) Inventors: Masaaki Makino, Kanagawa (JP); Takayuki Kumagawa, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/623,603

(22) Filed: Nov. 23, 2009

(30) Foreign Application Priority Data
Nov. 26, 2008 (JP) 2008-301374

(51) Int. Cl. G09G 5/00; G09G 5/36; G02B 27/00

(52) U.S. Cl. 345/581; 345/204; 345/556; 345/156; 359/613

(57) ABSTRACT

A commodity sales data processing apparatus including a display unit configured to display various kinds of information includes an angle-of-field setting unit configured to set an angle of field of a display screen of the display unit to a first angle of field or a second angle of field narrower than the first angle of field. An angle-of-field control section of the commodity sales data processing apparatus causes the angle-of-field setting unit to operate according to a state of use of the commodity sales data processing apparatus and set the angle of field of the display screen of the display unit to the first angle of field or the second angle of field.

### CROSS REFERENCE TO RELATED APPLICATION

This application is based upon and claims the benefit of priority from the prior Japanese Patent Application No. 2008-301374, filed Nov. 26, 2008, the entire contents of which are incorporated herein by reference.

### TECHNICAL FIELD

The present invention relates to a commodity sales data processing apparatus used for checkout processing in commodity sales stores such as a supermarket and a convenience store and a control method therefor.

### BACKGROUND

In the past, a commodity sales data processing apparatus such as a POS (Point Of Sales) terminal is used for checkout processing in commodity sales stores such as a supermarket and a convenience store. The commodity sales data processing apparatus includes an operator side display for displaying processing content to an operator, a customer side display for displaying checkout information and the like to a customer, a scanner that reads barcodes attached to commodities, a keyboard that receives the input of characters and the like by the depression of operation keys, and a card reader that reads information stored in a magnetic card such as a credit card.

The operator side display is designed to have a wide angle of field to allow an operator to visually recognize displayed content even if an angle for viewing a screen changes because of the difference in height of operators, the slight difference in posture during work, or the like. It is a general practice to also set, taking into account display performed to aim at the effectiveness of advertising such as commercial videos, the customer side display to have a wide angle of field to allow a customer to visually recognize displayed content from various angles.

For example, when the settlement of a transaction is performed by using a credit card or a debit card or when a point card is used, personal information such as a credit card number, age, sex, a name, the number of points of a customer is displayed on the operator side display. Therefore, from the viewpoint of protection of the personal information, some store takes measures of bonding a film having a very small louver layer to the surface of the operator side display to narrow the angle of field.

As a technique for protecting the personal information displayed on the screen in the same manner, a display apparatus disclosed in JP-A-2006-259930 is known. This display apparatus includes peep preventing means, an image photographing device, and counting means for detecting faces images with the image photographing device and counting the number of detected face images. When plural face images are counted by the counting means, the peep preventing means is caused to operate.

As described in JP-A-2008-107404, a display apparatus is developed that can electrically adjust an angle of field using a transparent-scattering switching element such as PNLC (Polymer Network Liquid Crystal) having polymer dispersion liquid crystal nipped by substrates provided with transparent electrodes.

In the display apparatus disclosed in JP-A-2008-107404, the refractive indexes of a polymer chain and the polymer dispersion liquid crystal are the same in a state in which voltage is applied between the transparent electrode pair. The transparent-scattering switching element changes to a transparent state. In this state, since an emission angle range of light emitted from a light source is limited, an angle of field of a display screen is narrowed. On the other hand, in a state in which voltage is not applied between the transparent electrode pair, the refractive indexes of the polymer chain and the polymer dispersion liquid crystal are different. In this state, the light emitted from the light source scatters when the light passes through the transparent-scattering switching element. Therefore, since the emission angle range of the light emitted from the light source is expanded, the angle of field of the display screen is widened.

As explained above, when the film having the very small louver layer is bonded to the surface of the operator side display, there is a disadvantage that the angle of field is always narrow. Therefore, an operation screen becomes less easily seen to cause inconvenience in the operation of the commodity sales data processing apparatus. In the case of a display with a pressure sensitive touch panel bonded on a display screen to enable touch operation, input sensitivity of the touch panel falls.

When there is an aisle behind the commodity sales data processing apparatus in a tenant store in a department store, a shopping center, or the like, it is necessary to narrow the angle of field to make displayed content of the operator side display invisible to customers. However, for example, in time when few people pass, when the aisle is closed, or when an arrangement position of the commodity sales data processing apparatus is changed, to the contrary, it is unnecessary to narrow the angle of field.

On the other hand, in the technique disclosed in JP-A-2006-259930, the peep preventing means is caused to operate according to only the number of face images shown on the image photographing device irrespectively of content displayed on the display screen. Therefore, the peep preventing means operates even when content that may be seen by anybody is only displayed.

There is also a commodity sales data processing apparatus that restricts access to important information such that only a part of operators can view personal information of customers, sales information of a store, and the like. In such a commodity sales data processing apparatus, when an operator not having access authority to the important information operates the commodity sales data processing apparatus, it is unnecessary to narrow the angle of field of the display. It is rather desirable to always set the angle of field wide if operability is taken into account.

### SUMMARY

The present invention has been devised in view of such circumstances and it is an object of the present invention to provide a commodity sales data processing apparatus that can automatically adjust an angle of field of a display screen of a display unit according to a state of use while keeping operability of the apparatus and appropriately prevent a peep and a control method therefor.

A commodity sales data processing apparatus according to an aspect of the present invention includes: a display unit configured to display various kinds of information; an angle-of-field setting unit configured to set an angle of field of a display screen of the display unit to a first angle of field or a second angle of field narrower than the first angle of field; and an angle-of-field control section configured to cause the angle-of-field setting unit to operate according to a state of use of the apparatus and set the angle of field of the display screen of the display unit to the first angle of field or the second angle of field.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is an external perspective view of a commodity sales data processing apparatus according to a first embodiment of the present invention;

FIG. 2 is a block diagram of a control circuit of the commodity sales data processing apparatus according to the first embodiment;

FIG. 3 is a schematic diagram of an example of the data structure of a date-and-time information table according to the first embodiment;

FIG. 4 is a flowchart of angle-of-field switching processing executed by the control unit in the first embodiment;

FIG. 5 is a diagram of a commodity sales system according to a second embodiment of the present invention;

FIG. 6 is a schematic diagram of an example of the data structure of an area information table according to the second embodiment;

FIG. 7 is a schematic diagram of an example of the data structure of a terminal ID table according to the second embodiment;

FIG. 8 is a flowchart of angle-of-field switching processing executed by a control unit in the second embodiment;

FIG. 9 is a schematic diagram of an arrangement change for commodity sales data processing apparatuses according to the second embodiment;

FIG. 10 is a schematic diagram of changed content of the area information table according to the second embodiment;

FIG. 11 is a schematic diagram of changed content of the terminal ID table according to the second embodiment;

FIG. 12 is a schematic diagram of the shape of a key switch according to a third embodiment of the present invention;

FIG. 13 is a schematic diagram of an example of the data structure of an operation mode table according to the third embodiment;

FIG. 14 is a schematic diagram of an example of the data structure of an authority information table according to the third embodiment; and

FIG. 15 is a flowchart of angle-of-field switching processing executed by a control unit in the third embodiment.

### DETAILED DESCRIPTION

### First Embodiment

A first embodiment of the present invention is explained below with reference to the accompanying drawings.

FIG. 1 is an external perspective view of a commodity sales data processing apparatus 1 according to this embodiment. The commodity sales data processing apparatus 1 includes an operator side display 2 and a customer side display 3 as display units according to this embodiment, a keyboard 4, a card reader 5, and a key switch 6.

The operator side display 2 displays various kinds of information such as processing content to an operator. The customer side display 3 displays various kinds of commercial information such as advertisements of commodities and a store, event information, news, and the weather forecast, the price for a transaction, and the like. The operator side display 2 and the customer side display 3 respectively include touch panels on the surfaces of display screens. An operator can input information by touch-operating the display screens of the operator side display 2 and the customer side display 3.

The keyboard 4 includes various operation keys such as numeric keys for inputting numerical values, a cash total key for calculating a total amount of a transaction, a closing key for declaring the end of the transaction, and a card settlement key for declaring settlement by a credit card.

The card reader 5 reads information stored in magnetic cards such as a credit card, a debit card, and a point card that stores preferential points given to a customer.

The key switch 6 can be turned when an operation key is inserted therein and switches various operation modes such as a registration mode, an inspection mode, a settlement mode, and a maintenance mode according to a turning stop position.

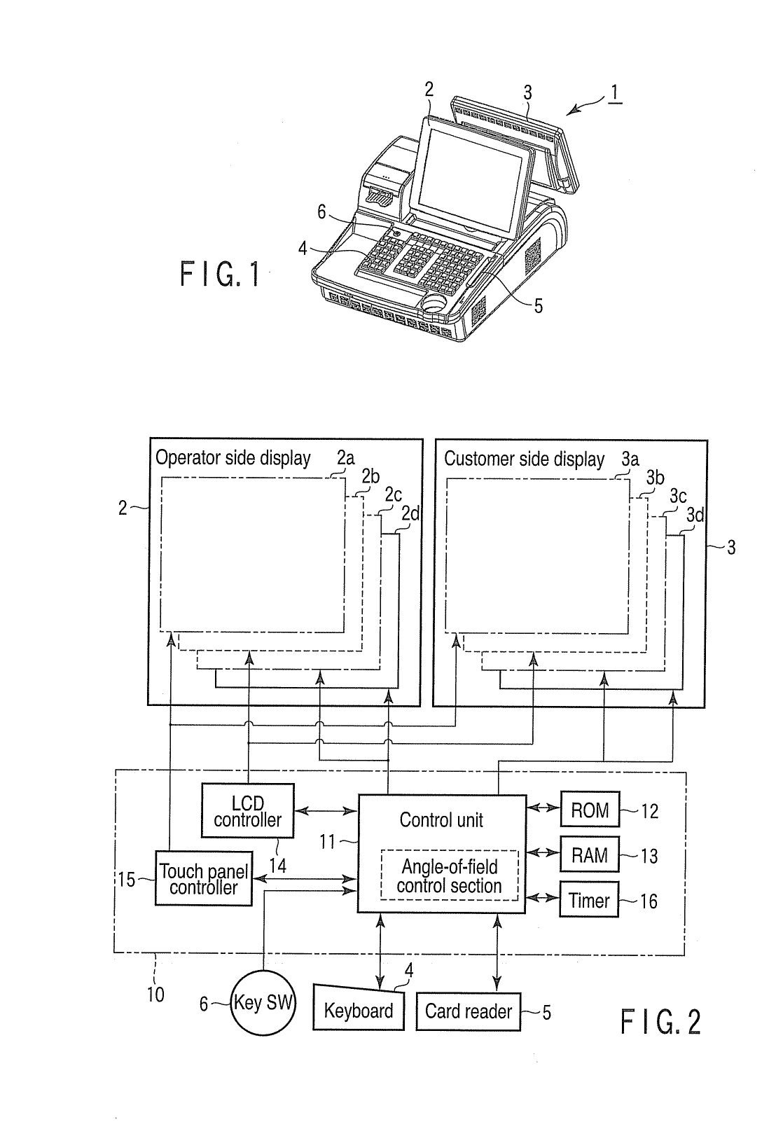

A control circuit of the commodity sales data processing apparatus 1 is explained. FIG. 2 is a block diagram of the control circuit of the commodity sales data processing apparatus 1. The control circuit is configured by connecting the operator side display 2, the customer side display 3, the keyboard 4, the card reader 5, and the key switch (SW) 6 to a circuit 10 incorporated in a main body of the commodity sales data processing apparatus 1.

The circuit 10 is configured by connecting a ROM (Read Only Memory) 12, a RAM (Random Access Memory) 13, an LCD (Liquid Crystal Display) controller 14, a touch panel controller 15, and a timer 16 to a control unit 11 via bus lines such as an address bus and a data bus.

The display screen of the operator side display 2 is configured by superimposing a touch panel 2a, an LCD panel 2b, a sheet polarizer 2c as an angle-of-field setting unit according to this embodiment, and a backlight system 2d, which have substantially the same sizes, in order from the top surface in a display direction. Like the operator side display 2, the customer side display 3 is configured by superimposing a touch panel 3a, an LCD panel 3b, a sheet polarizer 3c as the angle-of-field setting unit according to this embodiment, and a backlight system 3d, which have substantially the same sizes, in order from the top surface in the display direction.

The control unit 11 is main control means for the commodity sales data processing apparatus 1 including a CPU (Central Processing Unit) and a memory system. The ROM 12 has stored therein stationary information such as a computer program necessary for the operation of the commodity sales data processing apparatus 1. The RAM 13 forms storage areas for various kinds of work according to processing scenes. The timer 16 measures date and time.

The LCD controller 14 includes a controller that controls image display on the LCD panel 2b and a controller that controls image display on the LCD panel 3b. The touch panel controller 15 includes a controller that detects a touch operation position on the touch panel 2a and a controller that detects a touch operation position on the touch panel 3a. The touch operation positions detected by the touch panel controller 15 are transmitted to the control unit 11. The backlight systems 2d and 3d are turned on or off according to the reception of a predetermined control signal from the control unit 11.

The sheet polarizers 2c and 3c include transparent-scattering switching elements such as PNLC. A predetermined voltage signal is applied to the entire sheet polarizers 2c and 3c according to the output of the predetermined control signal from the control unit 11.

In a state in which the voltage signal is not applied to the sheet polarizers 2c and 3c, light emitted from the backlight systems 2d and 3d is diffused in the sheet polarizers 2c and 3c. The diffused light passes through the LCD panels 2b and 3b. At this point, light emitted from the screens of the operator side display 2 and the customer side display 3 is diffused not only in normal directions with respect to the screens but also in all directions. Therefore, fixed or higher luminance and a fixed or higher contrast ratio are maintained not only in the front directions but also in oblique directions of the screens. Displayed images on the operator side display 2 and the customer side display 3 can be visually recognized from a wide range. Such a state is hereinafter referred to as wide angle of field (first angle of field) state.

On the other hand, in a state in which the voltage signal is applied to the sheet polarizers 2c and 3c, the light emitted from the backlight systems 2d and 3d travels straight in the LCD panels 2b and 3b without being diffused in the sheet polarizers 2c and 3c. At this point, the light emitted from the screens of the operator side display 2 and the customer side display 3 is limited only to substantial normal directions with respect to the screens. Therefore, when the operator side display 2 and the customer side display 3 are viewed from the front, the luminance and the contrast of the display screens are maintained at degrees same as those obtained when the voltage is not applied. However, when the operator side display 2 and the customer side display 3 are viewed from oblique directions, the luminance markedly falls compared with that obtained when the operator side display 2 and the customer side display 3 are viewed from the front. Therefore, displayed images cannot be visually recognized. In the following explanation, a state in which the angle of field is narrow compared with a wide angle of field state in this way is referred to as narrow angle of field (second angle of field) state.

Date-and-time information table t1 (a date-and-time-information storing section) is stored in the ROM 12. In the date-and-time information table t1, information indicating which of the wide angle of field state and the narrow angle of field state the display screen of the operator side display 2 should be set is registered in association with date and time information indicating date and time. In this embodiment, date and time when the display screen of the operator side display 2 should be set in the narrow angle of field state is registered in the date-and-time information table t1. In other date and times, the display screen of the operator side display 2 should be set in the wide angle of field state. As the date and time when the display screen of the operator side display 2 should be set in the narrow angle of field state, for example, business date and time of a store having the commodity sales data processing apparatus 1 installed is set. When the date and time is set in this way, the display screen of the operator side display 2 is switched to the narrow angle of field state when customers are visiting the store. Therefore, there is no worry that the customers and the like peep displayed content. The display screen of operator side display 2 is switched to the wide angle of field state after the store is closed. Since displayed content is easily visually recognized when settlement processing for sales or the like is performed, work can be smoothly performed.

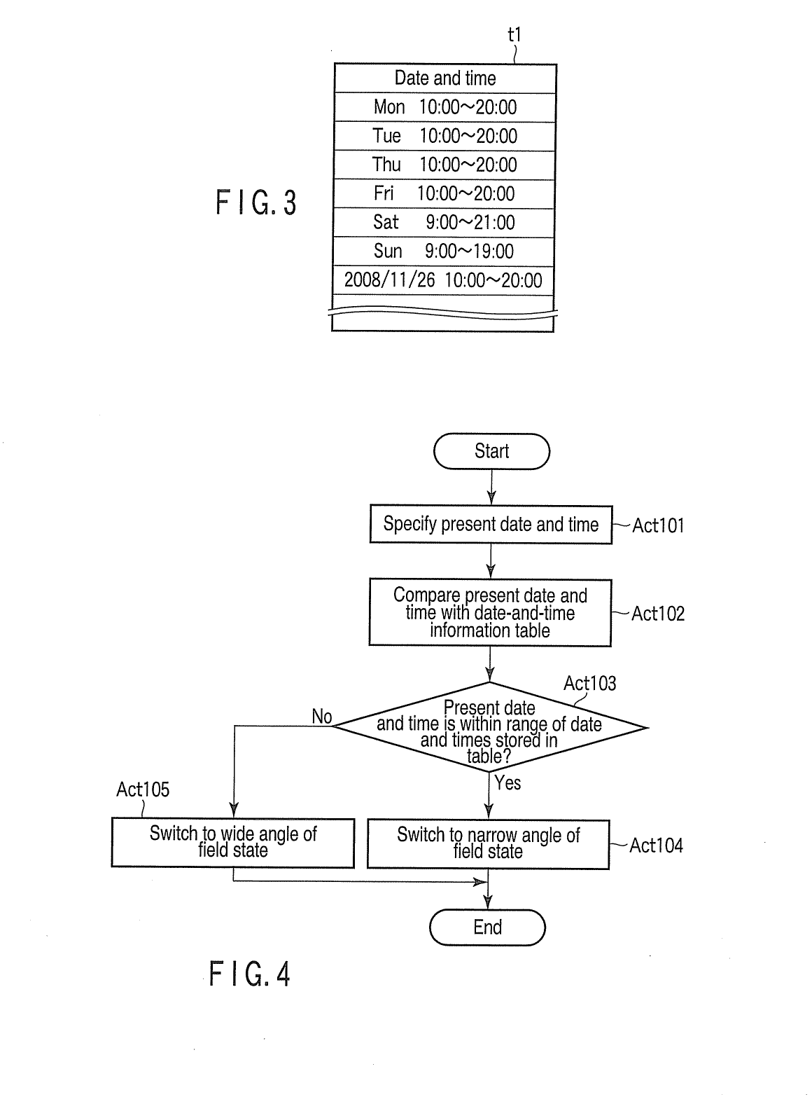

FIG. 3 is a schematic diagram of an example of the data structure of the date-and-time information table t1. For example, the store having the commodity sales data processing apparatus 1 installed is open from 10 o'clock to 20 o'clock in weekdays, open from 9 o'clock to 21 o'clock on Saturday, and open from 9 o'clock to 19 o'clock on Sunday. The store is closed on Wednesday. On Nov. 26, 2008, the store is specially open from 10 o'clock to 20 o'clock, although November 26 is Wednesday. On the basis of such business date and times, as shown in the figure, date and time information “Mon 10:00 to 20:00” (meaning 10 o'clock to 20 o'clock on Monday)”, “Tue 10:00 to 20:00” (meaning 10 o'clock to 20 o'clock on Tuesday), “Thu 10:00 to 20:00” (meaning 10 o'clock to 20 o'clock on Thursday), “Fri 10:00 to 20:00” (meaning 10 o'clock to 20 o'clock on Friday), “Sat 9:00 to 21:00” (meaning 9 o'clock to 21 o'clock on Saturday), “Sun 9:00 to 19:00” (meaning 9 o'clock to 19 o'clock on Sunday), and “2008/11/26 10:00 to 20:00” (meaning 10 o'clock to 20 o'clock on Nov. 26, 2008) is registered in the date-and-time information table t1. The date and time information registered in the date-and-time information table t1 can be changed according to, for example, the operation of a store server.

As a main function, the control unit 11 has an angle-of-field control section that causes the sheet polarizers 2c and 3c to operate according to a state of use of the commodity sales data processing apparatus 1 and set angles of field of the display screens of the operator side display 2 and the customer side display 3 to a wide angle of field or a narrow angle of field. In particular, the angle-of-field control section according to this embodiment specifies the present date and time as the state of use from the timer 16 and causes the sheet polarizers 2c and 3c to operate according to a type of an angle of field registered in the date-and-time information table t1 in association with the specified date and time.

Actions realized by the configuration explained above are explained below.

In this embodiment, the display screen of the operator side display 2 is usually in the wide angle of field state. The display screen of the operator side display 2 is switched to the narrow angle of field state according to the date and time information stored in the date-and-time information table t1.

FIG. 4 is a flowchart of processing for switching the angle of field of the display screen of the operator side display 2 executed by the control unit 11. This processing is executed at predetermined timing (e.g. every time one minute elapses) on the basis of an operation program stored in the ROM 12.

First, the control unit 11 specifies the present date and time with reference to the timer 16 (Act 101). The control unit 11 compares the specified present date and time and the date and time registered in the date-and-time information table t1 (Act 102) and determines whether the present date and time is within a range of any date and time set in the date-and-time information table t1 (Act 103). If the present date and time is, for example, 11 o'clock on Nov. 25, 2008 (Tuesday), the date and time is within a range of “Tue 10:00 to 20:00” set in the date-and-time information table t1. In such a case, the control unit 11 determines that the present date and time is within ranges of the date and times registered in the date-and-time information table t1 (Yes in Act 103) and outputs a control signal indicating that the display screen of the operator side display 2 should be set in the narrow angle of field state to the sheet polarizer 2c (Act 104). The sheet polarizer 2c that receives this signal maintains the narrow angle of field state if the display screen of the operator side display 2 is in the narrow angle of field state at present. If the display screen of the operator side display 2 is in the wide angle of field state, the sheet polarizer 2c starts application of a predetermined voltage signal to the sheet polarizer 2c itself. The display screen of the operator side display 2 is switched to the narrow angle of field state.

On the other hand, for example, if the present date and time is 21 o'clock on Nov. 25, 2008 (Tuesday), the present date and time is not within the ranges of all the date and times registered in the date-and-time information table t1. In such a case, the control unit 11 determines that the present date and time is not within the ranges of the date and times registered in the date-and-tie information table t1 (No in Act 103) and outputs a control signal indicating that the display screen of the operator side display 2 should be switched to the wide angle of field state to the sheet polarizer 2c (Act 105). The sheet polarizer 2c that receives this signal maintains the wide angle of field state if the display screen of the operator side display 2 is in the wide angle of field state. If the display screen of the operator side display 2 is in the narrow angle of field state, the sheet polarizer 2c stops the application of the predetermined voltage signal. The display screen of the operator side display 2 is switched to the wide angle of field state.

After setting the display screen of the operator side display 2 in the wide angle of field state or the narrow angle of field state in this way, the control unit 11 ends the processing for switching an angle of field shown in FIG. 4.

As explained above, the commodity sales data processing apparatus 1 according to this embodiment sets the angle of field of the display screen of the operator side display 2 to the wide angle of field or the narrow angle of field according to the information registered in the date and time information table t1. When this function is used, even in a tenant shop or the like in which an aisle that has little customer traffic or is closed depending on time is present behind the commodity sales data processing apparatus 1, if the time is registered in the date-and-time information table t1 in advance, the display screen of the operator side display 2 can be automatically switched to the narrow angle of field state. As a result, for the operator, labor and time for performing the operation for switching an angle of field every time are saved.

If information is registered in the date-and-time information table t1 such that the display screen of the operator side display 2 is switched to the wide angle of field state when a closing time comes, even when a store clerk displays sales data and the like on the operator side display 2 and views the sales data after the closure, it is easy to visually recognize displayed content and operability of the commodity sales data processing apparatus 1 is not spoiled.

### Second Embodiment

A second embodiment of the present invention is explained below with reference to the accompanying drawings.

This embodiment is different from the first embodiment in that the angle of field of the display screen of the operator side display 2 is set according to an installation area of the commodity sales data processing apparatus 1 in a store rather than date and time. Since the configuration of the commodity sales data processing apparatus 1 according to this embodiment is the same as that in the first embodiment, the same components are denoted by the same reference numerals and signs and explanation of the components is omitted.

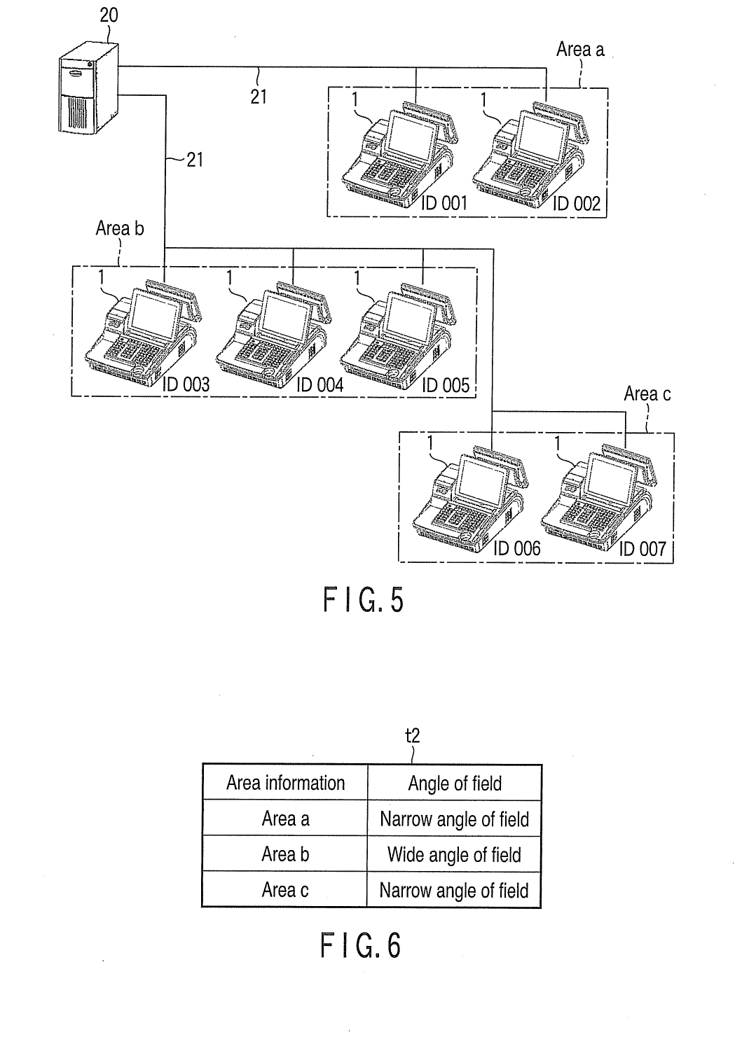

FIG. 5 is a schematic diagram of the configuration of a commodity sales system according to this embodiment. The commodity sales system includes plural commodity sales data processing apparatuses 1 and a store server 20 that is connected to the commodity sales data processing apparatuses 1 via a LAN (Local Area Network) cable 21 to be capable of communicating with each other and plays a role of supervising the management of customer information and commodity information. Terminal IDs “001” to “007” are respectively allocated to the commodity sales data processing apparatuses 1 as peculiar identifiers. The commodity sales data processing apparatuses 1 having the terminal IDs “001” and “002” are arranged in an area “a” where miscellaneous goods for daily use are sold in the store. The commodity sales data processing apparatuses 1 having the terminal IDs “003”, “004”, and “005” are arranged in an area “b” where a service counter is installed in the store. The commodity sales data processing apparatuses 1 having the terminal IDs “006” and “007” are arranged in an area “c” where foodstuffs are sold in the store.

The ROM 12 of each of the commodity sales data processing apparatuses 1 has stored therein an area information table t2 (an area-information storing section) in which information concerning which of a wide angle of field and a narrow angle of field the angle of field of the display screen of the operator side display 2 should be set is registered in association with area information. FIG. 6 is a schematic diagram of an example of the data structure of the area information table t2. In the area information table t2, information for specifying the respective areas “a”, “b”, and “c” is registered as the area information. Types of the angle of field of the display screen of the operator side display 2 that should be set by the commodity sales data processing apparatuses 1 present in the areas are respectively registered in association with these kinds of area information. The area “b” is the area where the service counter is installed. Since little personal information is handled, a type of an angle of field in the area is set to the wide angle of field.

On the other hand, the areas “a” and “c” are respectively the areas where miscellaneous goods for daily use and foodstuffs are sold. Therefore, there are a lot of opportunities of handling personal information. For example, when card settlement by a credit card or the like is performed, personal information such as a card number is displayed on the operator side display 2. Further, since customers waiting for checkout and the like tend to crowd near a register counter, a type of an angle of field in the area information table t2 is set to the narrow angle of field to prevent the personal information displayed on the operator side display 2 from being peeped.

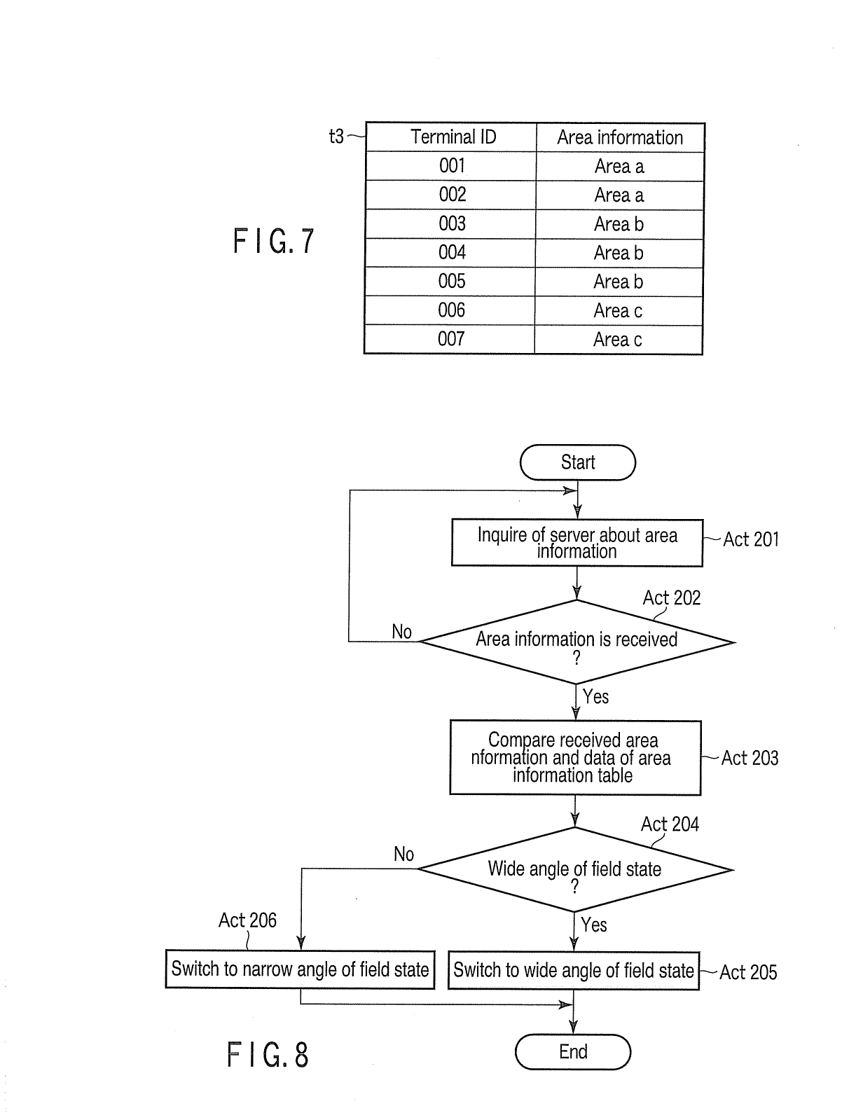

Storing means such as a hard disk included in the store server 20 has stored therein a terminal ID table t3 for specifying areas where the commodity sales data processing apparatuses 1 are installed. FIG. 7 is a schematic diagram of an example of the data structure of the terminal ID table t3. Area information for specifying the areas where the commodity sales data processing apparatuses 1 specified by terminal IDs “001” to “007” are installed is registered in the terminal ID table t3 in association with the terminal IDs. A relation between the terminal IDs and the area information is as already explained with reference to FIG. 6. Specifically, the area “a” is registered in association with the terminal IDs “001” and “002”, the area “b” is registered in association with the terminal IDs “003”, “004”, and “005”, and the area “c” is registered in association with the terminal IDs “006” and “007”.

As in the first embodiment, the control unit 11 according to this embodiment has an angle-of-field control section that causes the sheet polarizers 2c and 3c to operate according to a state of use of the commodity sales data processing apparatus 1 and set the angles of field of the display screens of the operator side display 2 and the customer side display 3 to the wide angle of field or the narrow angle of field. In particular, the angle-of-field control section according to this embodiment specifies an installation area of the commodity sales data processing apparatus 1 as the state of use and causes the sheet polarizers 2c and 3c to operate according to a type of an angle of field registered in the area information table t2 in association with the specified installation area.

Actions realized by the configuration explained above are explained below.

FIG. 8 is a flowchart of processing for switching the angle of field of the display screen of the operator side display 2 executed by the control unit 11. This processing is executed at predetermined timing (e.g., every time one minute elapses or during starting of a system) on the basis of an operation program stored in the ROM 12 in each of the commodity sales data processing apparatuses 1.

First, the control unit 11 inquires of the store server 20 about information concerning an area to which the operator side display 2 belongs (Act 201). Specifically, the control unit 11 transmits a terminal ID of the operator side display 2 and an identifier for requesting notification of area information via the LAN cable 21. The store server 20 that receives the terminal ID and the identifier from the commodity sales data processing apparatus 1 specifies area information associated with the terminal ID with reference to the terminal ID table t3. The store server 20 returns the specified area information to the commodity sales data processing apparatus 1 specified by the terminal ID.

After inquiring of the store server 20 about the information concerning an area to which the operator side display 2 belongs, the control unit 11 determines whether a reply is received from the store server 20 (Act 202). If there is no reply from the store server 20 (No in Act 202), again, the control unit 11 inquires of the store server 20 about information concerning an area to which the operator side display 2 belongs. On the other hand, if a reply is received from the store server 20 (Yes in Act 202), the control unit 11 compares received area information and the area information set in the area information table t2 (Act 203) and determines whether a type of an angle of field associated with the received area information is the wide angle of field (Act 204). If the specified type of an angle of field is the wide angle of field (Yes in Act 204), the control unit 11 outputs a control signal indicating that the display screen of the operator side display 2 should be switched to the wide angle of field state to the sheet polarizer 2c (Act 205). The sheet polarizer 2c that receives this signal maintains the wide angle of field state if the display screen of the operator side display 2 is in the wide angle of field state at present. If the display screen of the operator side display 2 is in the narrow angle of field state, the sheet polarizer 2c stops application of the predetermined voltage signal to the sheet polarizer 2c itself. The display screen of the operator side display 2 is switched to the wide angle of field state.

On the other hand, if the specified type of an angle of field is the narrow angle of field (No in Act 204), the control unit 11 outputs a control signal indicating that the display screen of the operator side display 2 should be switched to the narrow angle of field state to the sheet polarizer 2c (Act 206). The sheet polarizer 2c that receives this signal maintains the narrow angle of field state if the display screen of the operator side display 2 is in the narrow angle of field state at present. If the display screen of the operator side display 2 is in the wide angle of field state, the sheet polarizer 2c starts application of the predetermined voltage signal to the sheet polarizer 2c itself. The display screen of the operator side display 2 is switched to the narrow angle of field state.

After setting the display screen of the operator side display 2 in the wide angle of field state or the narrow angle of field state in this way, the control unit 11 ends the processing for switching an angle of field.

When the commodity sales data processing apparatuses 1 shown in FIG. 5 execute the angle of field switching processing, the operator side displays 2 of the commodity sales data processing apparatuses 1 having the terminal IDs “003”, “004”, and “005” are switched to the wide angle of field state. The displays screens of the operator side displays 2 of the commodity sales data processing apparatuses 1 having the terminal IDs “001”, “002”, “006”, and “007” are switched to the narrow angle of field state.

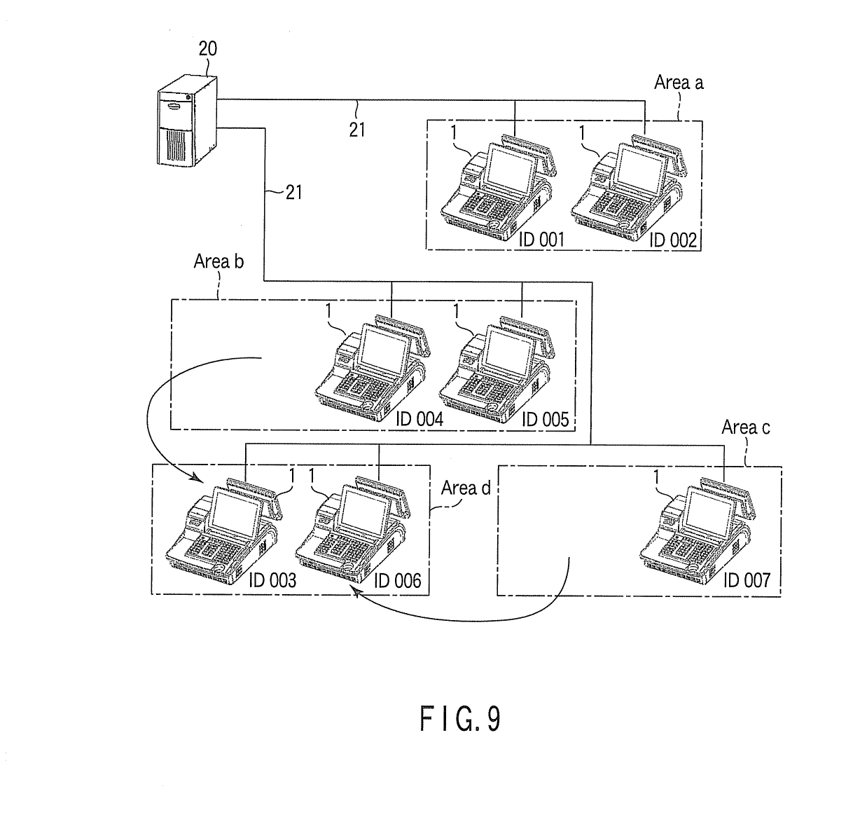

Processing performed when a new area is provided in the store and the commodity sales data processing apparatuses 1 are moved to the area as shown in FIG. 9 is explained below. As an example, an area “d” is provided as the new area and the commodity sales data processing apparatuses 1 having the terminal IDs “003” and “006” are moved to the area “d”. As such movement of the commodity sales data processing apparatuses 1, it is conceivable to move the commodity sales data processing apparatuses 1 to a specific area where an event such as a sale is held. The angle of field of the display screens of the operator side displays 2 in the area “d” is set to the narrow angle of field.

In the movement, the content of the area information table t2 is changed as shown in FIG. 10. Changes from the area information table t2 shown in FIG. 6 are underlined. Specifically, the area “d” is registered anew as area information and the narrow angle of field is registered as an angle of field associated with the area “d”. The area information table t2 with the content changed in this way is delivered from the store server 20 to the commodity sales data processing apparatuses 1 in the store via the LAN cable 21. The commodity sales data processing apparatuses 1 that receive the area information table t2 delivered from the store server 20 update the present area information table t2 with the received area information table t2.

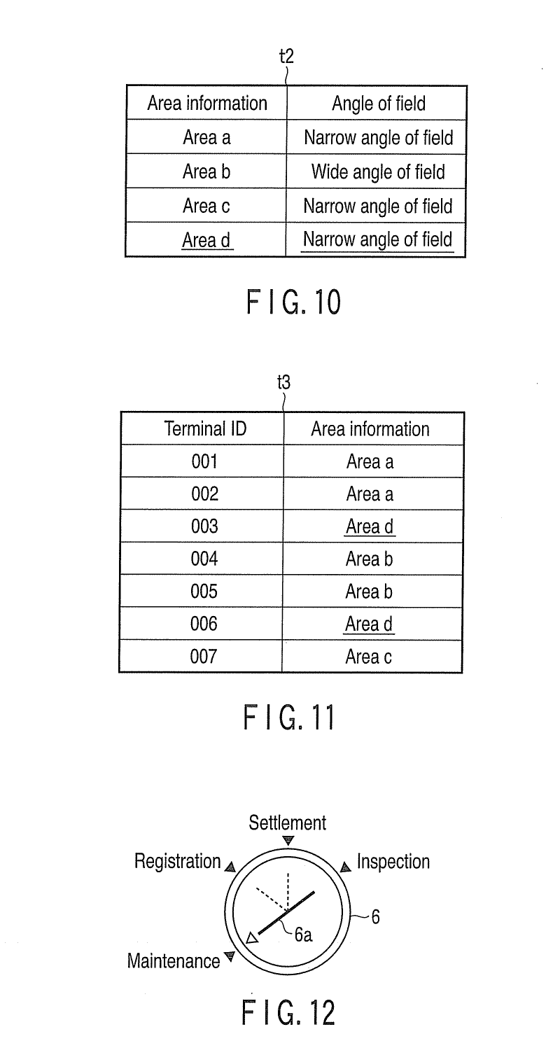

Further, as shown in FIG. 11, the commodity sales data processing apparatuses 1 change the content of the terminal ID table t3 stored in the store server 20. Changes from the terminal ID table t3 shown in FIG. 7 are underlined. Specifically, area information associated with the terminal IDs “003” and “006” is changed to the area “d”.

After the content of the area information table t2 and the content of the terminal ID table t3 are changed in this way, as a result of execution of the processing shown in FIG. 8, the commodity sales data processing apparatuses 1 having the terminal IDs “004” and “005” are switched to the wide angle of field state and the commodity sales data processing apparatuses 1 having the terminal IDs “001”, “002”, “003”, “006”, and “007 are switched to the narrow angle of field state.

As explained above, the commodity sales data processing apparatus 1 according to this embodiment specifies an area where the commodity sales data processing apparatus 1 is installed and automatically sets the display screen of the operator side display 2 to the angle of field registered in the area information table t2. Therefore, it is possible to realize an appropriate angle of field of the display screen of the operator side display 2 corresponding to an installation location without requiring labor and time for performing switching operation.

Even when the installation area of the commodity sales data processing apparatus 1 is changed, if the registration contents of the area information table t2 and the terminal ID table t3 are changed according to the change and the area information table t2 after the change is collectively delivered from the store server 20 to the commodity sales data processing apparatuses 1, a desired angle of field of the display screen of the operator side displays 2 can be realized. In other words, it is possible to save labor and time for changing the angle of field of the display screen of the operator side display 2 for each of the commodity sales data processing apparatuses 1 in the store.

Since the angle of field of the display screen of the operator side display 2 can be changed, it is unnecessary to prepare two kinds of commodity sales data processing apparatuses in order to properly use the commodity sales data processing apparatuses in an installation location where the wide angle of field is desirable and an installation location where the narrow angle of field is desirable.

### Third Embodiment

A third embodiment of the present invention is explained below with reference to the accompanying drawings.

This embodiment is different from the embodiments explained above in that the angle of field of the display screen of the operator side display 2 is set according to operation authority of an operator of the commodity sales data processing apparatus 1 rather than date and time and an arrangement location of the commodity sales data processing apparatus 1. Since the configuration of the commodity sales data processing apparatus 1 is the same as that in the first embodiment, the same components are denoted by the same reference numerals and signs and explanation of the components is omitted.

FIG. 12 is a schematic diagram of the shape of the key switch 6. The key switch 6 is a rotary switch and has a keyhole 6a having a predetermined shape. The key switch 6 can be turned only when a dedicated key is inserted into the keyhole 6a. The key switch 6 changes, according to a stop position of the key switch 6, the mode of the commodity sales data processing apparatus 1 to an operation mode set in advance.

Operation modes to which the mode of the commodity sales data processing apparatus 1 can be changed by using the key switch 6 include the registration mode, the inspection mode, the settlement mode, and the maintenance mode as already explained. The registration mode is a mode for processing sales data of commodities on the basis of input commodity information. The inspection mode is a mode for editing inspection report data on the basis of the sales data processed in the registration mode and printing or displaying this data. The settlement mode is a mode for editing, in the same manner as the inspection mode, settlement data on the basis of the sales data, printing or displaying this data, and erasing the individually stored sales data to replace the sales data with the settlement data. The maintenance mode is a mode for performing a setting change such as update of the system having relatively large influence on the system and viewing a database related to personal information such as a customer master stored in the ROM 12, a hard disk drive (not shown in the figure), or the like.

A turning range of the key switch 6 is restricted by a type of a key inserted therein. A mode change among the registration mode, the inspection mode and the settlement mode can be performed by using a normal key carried by general store clerks of the store. However, a mode change to the maintenance mode can be performed by using only a dedicated key carried by a part of the store clerks such as manager-level store clerks.

The ROM 12 has stored therein an operation mode table t4 and an authority information table t5 (an authority-information storing section). Operation authority of people who can perform processing in the respective operation modes is registered in the operation mode table t4 in association with information indicating types of the operation modes. Information indicating which of the wide angle of field and the narrow angle of field the angle of field of the display screen of the operator side display 2 should be set is registered in the authority information table t5 in association with the operation authority.

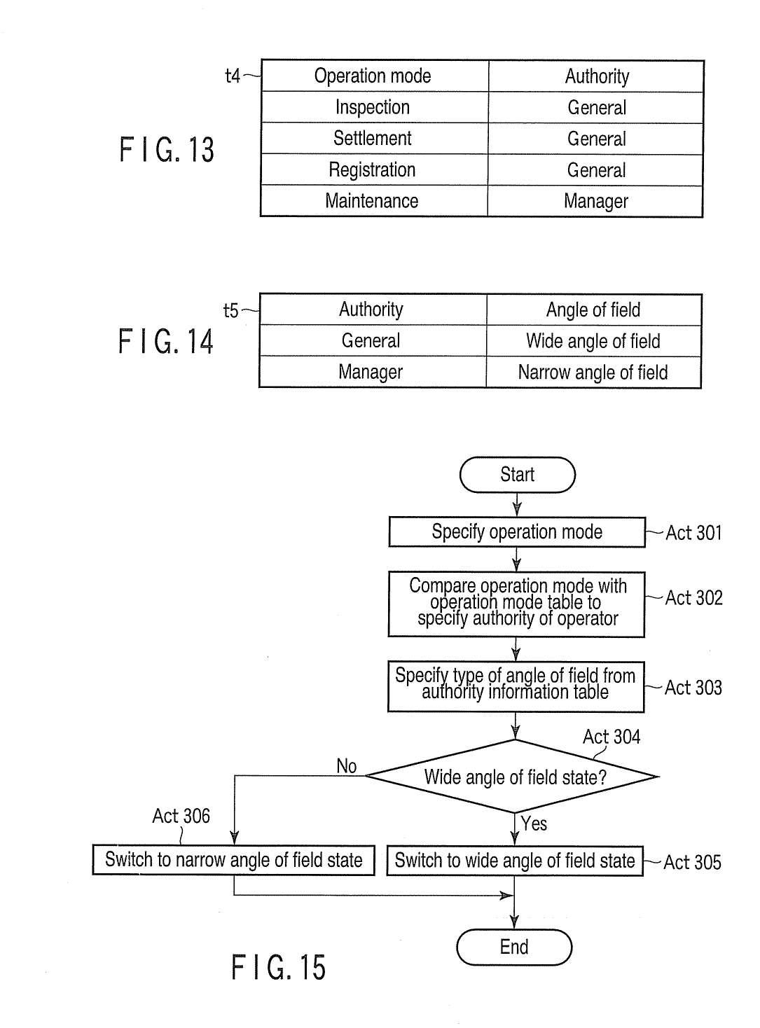

FIG. 13 is a schematic diagram of an example of the data structure of the operation mode table t4. In the operation mode table t4 according to this embodiment, “general” is associated with the respective operation modes of inspection, settlement, and registration as operation authority for allowing a person to perform processing in the operation modes and “manager” is associated with the maintenance mode as operation authority for allowing a person to perform processing in the maintenance mode. A person having the authority of the manager can also perform processing that people having general authority can perform, i.e., the processing in the respective operation modes of inspection, settlement, and registration.

FIG. 14 is a schematic diagram of an example of the data structure of the authority information table t5. In the authority information table t5 according to this embodiment, information indicating the wide angle of field is registered in association with the general authority and information indicating the narrow angle of field is registered in association with the authority of the manager.

As in the first embodiment, the control unit 11 according to this embodiment has an angle-of-field control section that causes the sheet polarizers 2c and 3c to operate according to a state of use of the commodity sales data processing apparatus 1 and set the angles of field of the display screens of the operator side display 2 and the customer side display 3 to the wide angle of field or the narrow angle of field. In particular, the angle-of-field control section according to this embodiment specifies operation authority of the operator as the state of use and causes the sheet polarizers 2c and 3c to operate according to a type of an angle of field stored in the authority information table t5 in association with the specified operation authority.

Actions realized by the configuration explained above are explained below.

FIG. 15 is a flowchart of processing for switching the angle of field of the display screen of the operator side display 2 executed by the control unit 11. This processing is executed in response to the change-over of the key switch 6 and on the basis of the operation program stored in the ROM 12.

First, the control unit 11 specifies an operation mode set at present in response to an electric signal output according to a turning stop position of the key switch 6 (Act 301). Subsequently, the control unit 11 specifies a type of operation authority set in association with the present operation mode from the operation mode table t4 (Act 302). The control unit 11 specifies a type of an angle of field associated with the specified type of operation authority from the authority information table t5 (Act 303).

Thereafter, the control unit 11 determines whether the specified type of an angle of field is the wide angle of field (Act 304). If the specified type of an angle of field is the wide angle of field (Yes in Act 304), the control unit 11 outputs a control signal indicating that the display screen of the operator side display 2 should be switched to the wide angle of field state to the sheet polarizer 2c (Act 305). The sheet polarizer 2c that receives this signal maintains the wide angle of field state if the display screen of the operator side display 2 is in the wide angle of field state at present. If the display screen of the operator side display 2 is in the narrow angle of field state, the sheet polarizer 2c stops application of the predetermined voltage signal to the sheet polarizer 2c itself. The display screen of the operator side display 2 is switched to the wide angle of field state.

On the other hand, if the specified type of an angle of field is the narrow angle of field (No in Act 304), the control unit 11 outputs a control signal indicating that the display screen of the operator side display 2 should be switched to the narrow angle of field state to the sheet polarizer 2c (Act 306). The sheet polarizer 2c that receives this signal maintains the narrow angle of field state if the display screen of the operator side display 2 is in the narrow angle of field state at present. If the display screen of the operator side display 2 is in the wide angle of field state, the sheet polarizer 2c starts application of the predetermined voltage signal to the sheet polarizer 2c itself. The display screen of the operator side display 2 is switched to the narrow angle of field state.

After switching the display screen of the operator side display 2 to the wide angle of field state or the narrow angle of field state in this way, the control unit 11 ends the angle of field switching processing and executes processing corresponding to the set operation mode. As a result of the control unit 11 executing the operation according to the flowchart shown in FIG. 15, if the operation mode is set in any one of the operation modes of inspection, settlement, and registration according to the operation of the key switch 6, the display screen of the operator side display 2 is switched to the wide angle of field state. When the operation mode is set in the maintenance mode, the display screen of the operator side display 2 is switched to the narrow angle of field state.

As explained above, the commodity sales data processing apparatus 1 according to this embodiment sets, with reference to the authority information table t5, the angle of field of the display screen of the operator side display 2 to the wide angle of field or the narrow angle of field according to operation authority of the operator. Therefore, if the narrow angle of field is set in association with operation authority for allowing a person to handle highly confidential information such as the personal information registered in the authority information table t5 in advance, the display screen of the operator side display 2 is surely switched to the narrow angle of field state when the person having the operation authority handles the highly confidential information. This makes it possible to reduce the likelihood of a peep of displayed content.

If the wide angle of field is set in the authority information table t5 in association with operation authority of a person who does not handle the highly confidential information, the display screen of the operator side display 2 is switched to the wide angle of field state when the person having the operation authority performs a job. Therefore, the operation screen of the operator side display 2 is not less easily seen from the operator of the commodity sales data processing apparatus 1. This makes it possible to smoothly carry out a job.

### Modifications

The state of use of the commodity sales data processing apparatus 1 in which the angles of field of the display screens of the operator side display 2 and the customer side display 3 should be switched to the narrow angle of field is not limited to a state where date and time, an installation area, and authority of the operator satisfy predetermined conditions. The display screen of the operator side display 2 may be switched to the narrow angle of field state in other situations in which indefinite people can see the display screen of the operator side display 2.

In the above explanation of the embodiments, the control of the angle of field is performed only for the operator side display 2. However, the control of the angle of field may be performed for the customer side display 3. In performing the control, it is conceivable to, for example, control the angle of field of the display screen of the customer side display 3 at timing same as the timing when the angle of field of the display screen of the operator side display 2 is switched explained in the embodiments.

In the above explanation of the embodiments, the sheet polarizer 2c or the sheet polarizer 3c is arranged between the LCD panel 2b and the backlight system 2d or between the LCD panel 3b and the backlight system 3d. However, an arrangement position of the sheet polarizers 2c and 3 is not limited to this. For example, the sheet polarizer 2c may be arranged between the touch panel 2a and the LCD panel 2b or the sheet polarizer 3c may be arranged between the touch panel 3a and the LCD panel 3b.

In the above explanation of the embodiments, the LCD is adopted for the operator side display 2 and the customer side display 3. However, a display system of the displays is not limited to the LCD. Other display elements such as an FED (Field Emission Display), a plasma display, an EL (Electro Luminescence) display, and a CRT (Cathode Ray Tube) may be adopted.

In the above explanation of the embodiments, the angles of field of the display screens of the operator side display 2 and the customer side display 3 are set to the wide angle of field or the narrow angle of field. However, the angles of field of the display screens of the operator side display 2 and the customer side display 3 can be set in a larger number of stages. For example, the sheet polarizers 2c and 3c that can set the angle of field in three stages including an intermediate angle of field between the narrow angle of field and the wide angle of field in addition to the narrow angle of field and the wide angle of field are adopted. The angles of field of the display screens of the operator side display 2 and the customer side display 3 are controlled to be set to any one of the angles of field in the three stages according to a state of use of the commodity sales data processing apparatus 1 such as date and time, an installation area, or operation authority of the operator. By adopting such a configuration, it is possible to perform detailed setting of an angle of field more corresponding to the state of use.

In the first embodiment, the angle of field of the display screen of the operator side display 2 is set according to date and time. However, the angle of field may be set according to only time or only date rather than date and time.

In the second embodiment, the control unit 11 inquires of the store server 20 about an area in which the operator side display 2 is arranged to specify the area. However, a method of specifying the area is not limited to this. For example, the control unit 11 may receive the input of an area by operation input from the keyboard 4 or the touch panel 2a to specify an area in which the operator side display 2 is arranged according to the input area.

In the third embodiment, a method of specifying operation authority of the operator is not limited to the method of specifying operation authority on the basis of a set operation mode. It is conceivable to adopt, for example, a method of reading a magnetic card having operation authority of the operator stored therein with the card reader 5 to specify the operation authority, a method of reading a barcode indicating operation authority, which is attached to a name plate of the operator, with a barcode reader connected to the commodity sales data processing apparatus 1 to specify the operation authority, and a method of wirelessly reading a radio ID tag having operation authority of the operator stored therein using a radio ID tag reader connected to the commodity sales data processing apparatus 1 to specify the operation authority.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. A commodity sales data processing apparatus comprising:
a display unit configured to display various kinds of information;
an angle-of-field setting unit configured to set an angle of field of a display screen of the display unit to a first angle of field or a second angle of field narrower than the first angle of field; and
an angle-of-field control section configured to cause the angle-of-field setting unit to operate according to a state of use of the apparatus and set the angle of field of the display screen of the display unit to the first angle of field or the second angle of field.

2. The apparatus according to clam 1, further comprising:
a date-and-time-information storing unit configured to have stored therein types of the first angle of field or the second angle of field in association with date and time information; and
a timer configured to measure date and time, wherein
the angle-of-field control section specifies present date and time as the state of use from the timer and causes the angle-of-field setting unit to operate according to a type of a angle of field stored in the date-and-time-information storing unit in association with the specified date and time and set the angle of field of the display screen of the display unit to the first angle of field or the second angle of field.

3. The apparatus according to claim 1, further comprising an area-information storing unit configured to have stored therein types of the first angle of field or the second angle of field in association with area information, wherein
the angle-of-field control section specifies an installation area of the commodity sales data processing apparatus as the state of use and causes the angle-of-field setting unit to operate according to a type of an angle of field stored in the area-information storing unit in association with the specified installation area and set the angle of field of the display screen of the display unit to the first angle of field or the second angle of field.

4. The apparatus according to claim 3, wherein the angle-of-field control section inquires of a server connected to the commodity sales data processing apparatus via a network to specify the installation area of the commodity sales data processing apparatus.

5. The apparatus according to claim 1, further comprising an authority-information storing unit configured to have stored therein types of the first angle of field or the second angle of field in association with information indicating operation authority of an operator, wherein
the angle-of-field control section specifies operation authority of the operator as the state of use and causes the angle-of-field setting unit to operate according to a type of an angle of field stored in the area-information storing unit in association with the specified operation authority and set the angle of field of the display screen of the display unit to the first angle of field or the second angle of field.

6. The apparatus according to claim 5, further comprising a mode switching unit configured to switch plural operation modes including an operation mode in which use of the commodity sales data processing apparatus is limited to a person having predetermined operation authority, wherein
the angle-of-field control section specifies operation authority of the operator on the basis of an operation mode being executed by the commodity sales data processing apparatus.

7. The apparatus according to claim 6, wherein the mode switching unit is a key switch that switches the operation modes according to a turning stop position with a turning range thereof limited according to a type of a key inserted into a keyhole.

8. The apparatus according to claim 1, wherein a touch panel is provided on the display screen of the display unit.

9. The apparatus according to claim 8, wherein the angle-of-field setting unit is provided further on an inner side of the display unit than the touch panel.

10. A commodity sales data processing apparatus comprising:
an operator side display unit configured to display various kinds of information to an operator;
a customer side display unit configured to display various kinds of information to a customer;
an angle-of-field setting unit configured to set angles of field of display screens of the operator side display unit and the customer side display unit to a first angle of field or a second angle of field narrower than the first angle of field; and
an angle-of-field control section configured to cause the angle-of-field setting unit to operate according to a state of use of the apparatus and set the angles of field of the display screen of the operator side display unit and the customer side display unit to the first angle of field or the second angle of field.

11. A control method for a commodity sales data processing apparatus including a display unit configured to display various kinds of information and an angle-of-field setting unit configured to set an angle of field of a display screen of the display unit to a first angle of field or a second angle of field narrower than the first angle of field, the method comprising:
specifying a state of use of the commodity sales data processing apparatus; and
causing the angle-of-field setting unit to operate according to the specified state of use and set the angle of field of the display screen of the display unit to the first angle of field or the second angle of field.

12. The method according to claim 11, wherein the state of use of the commodity sales data processing apparatus is present date and time indicated by a timer that measures date and time.

13. The method according to claim 11, wherein the state of use of the commodity sales data processing apparatus is an installation area of the commodity sales data processing apparatus.

14. The method according to claim 11, wherein the state of use of the commodity sales data processing apparatus is operation authority of an operator.
